(19) United States
(12) Patent Application Publication
(10) Pub. No.: US 2020/0082083 A1
(43) Pub. Date: Mar. 12, 2020

(54) APPARATUS AND METHOD FOR VERIFYING MALICIOUS CODE MACHINE LEARNING CLASSIFICATION MODEL

(71) Applicant: WINS Co., Ltd., Gyeonggi-do (KR)

(72) Inventors: Byung Hwan Choi, Gyeonggi-do (KR); In Ho Kim, Seoul (KR); Seung Yeon Park, Seongnam-si (KR)

(73) Assignee: WINS Co., Ltd., Gyeonggi-do (KR)

(21) Appl. No.: 16/553,054

(22) Filed: Aug. 27, 2019

(30) Foreign Application Priority Data
Sep. 6, 2018 (KR) 10-2018-0106470

(51) Int. Cl. G06F 21/56; G06N 5/04

(52) U.S. Cl. CPC G06F 21/567; G06N 5/04; G06F 2221/033; G06F 21/566; G06F 21/562

(57) ABSTRACT

Disclosed is an apparatus for verifying a malicious code machine learning classification model, which includes: a main feature processing subsystem performing feature extracting and processing functions in an input file; and a multi-layer cyclic verification subsystem performing multi-layer verification in order to determine whether the file is normal or malicious based on the extracted and processed features to verify a machine learning model that classifies malicious codes, thereby ensuring reliability of a prediction result for a machine learning model.

### CROSS-REFERENCE TO RELATED APPLICATIONS

This application claims priority to Republic of Korea Patent Application No. 10-2018-0106470, filed on 6 September 2018 in the Korean Intellectual Property Office, the entire contents of which is hereby incorporated by reference in its entirety.

### p BACKGROUND OF THE DISCLOSURE

### 1. Field of the Disclosure

The present invention relates to verification of a malicious code machine learning classification model, and particularly, to an apparatus and a method for verifying a malicious code machine learning classification model, which may ensure verification and reliability of a machine learning classification model by deriving predictive information for a file suspected of maliciousness by various machine learning models such as CNN and DNN and determining the similarity for the malicious suspicious file by performing multi-layer cyclic verification that performs single or multiple similarity discrimination based on results after static and dynamic analysis of the malicious suspicious file for verification of the predictive information derived at this time.

### 2. Background of the Disclosure

The quantity of new or variant malicious codes is increasing day by day, and there is a limit in many ranges including manpower, a temporal part, etc., in analyzing the increased quantity manually. Therefore, there are various modeling and analysis methods using machine learning. However, there is a problem of securing the reliability of predictive information discriminated by the machine learning.

Accordingly, a variety of studies are needed to verify the reliability of a machine learning model for classifying malicious codes and secure reliability for a prediction result.

### SUMMARY OF THE DISCLOSURE

At The present invention has been made in an effort to provide an apparatus for verifying a malicious code machine learning classification model for verifying a machine learning model that classifies malicious codes through inter-file multi-layer cyclic verification and ensuring reliability for a prediction result of the machine learning model.

The present invention has also been made in an effort to provide a method for verifying a malicious code machine learning classification model for verifying a machine learning model that classifies malicious codes through inter-file multi-layer cyclic verification and ensuring reliability for a prediction result of the machine learning model.

An exemplary embodiment of the present invention provides an apparatus for verifying a malicious code machine learning classification model, which includes: a main feature processing subsystem performing feature extracting and processing functions in an input file; and a multi-layer cyclic verification subsystem performing multi-layer verification in order to determine whether the file is normal or malicious based on the extracted and processed features.

In the apparatus for verifying a malicious code machine learning classification model according to an exemplary embodiment of the present invention, the main feature processing subsystem may include a feature extraction module extracting features related to static analysis information which may be obtained without execution of the file and features related to dynamic analysis information which may be obtained through execution of the file, and a main feature processing module selecting and categorizing main features which may be used at the time of performing a malicious action among the extracted features related to the static analysis information and features related to the dynamic analysis information.

In the apparatus for verifying a malicious code machine learning classification model according to an exemplary embodiment of the present invention, the multi-layer cyclic verification subsystem may include a main feature relative comparison module comparing the selected main features with the main features of the normal files and the main features of the malicious files, respectively to calculate the normal similarity rate and the malicious similarity rate, an operation sequence based comparison modeling module comparing the features related to the operation sequence among the selected main features with the features related to the operation sequence of the normal files and the features related to the operation sequence of the malicious files, respectively to calculate the normal similarity rate and the malicious similarity rate, a function sequence based comparison modeling module comparing the features related to the function sequence among the selected main features with the features related to the function sequence of the normal files and the features related to the function sequence of the malicious files, respectively to calculate the normal similarity rate and the malicious similarity rate, and a determination unit determining whether the malicious suspicious file is normal or malicious by computing the final normal similarity rate and the final malicious similarity rate based on the normal similarity rate and the malicious similarity rate calculated by the main feature relative comparison module, the normal similarity rate and the malicious similarity rate calculated by the operation sequence based comparison modeling module, and the normal similarity rate and the malicious similarity rate calculated by the function sequence based comparison modeling module and by comparing the final normal similarity rate and the final malicious similarity rate.

In the apparatus for verifying a malicious code machine learning classification model according to an exemplary embodiment of the present invention, the main feature relative comparison module may perform an operation of acquiring the number of categories whose contents match each other by comparing contents of the main features classified for each selected category with the contents of the main features of the normal files and the contents of the main features of the malicious files, respectively, an operation of generating feature vectors by setting the categories whose contents match each other to 1 and setting the categories whose contents do not match each other to 0 based on the comparison result, an operation of computing a similarity rate for each feature by comparing the features of the categories whose contents match each other with the main features of the normal files and the main features of the malicious files, respectively in unit of block based on the number of categories whose contents match each other, and an operation of calculating the normal similarity rate for the normal file and the malicious similarity rate for the malicious file based on the feature vectors and the similarity rate for each feature.

In the apparatus for verifying a malicious code machine learning classification model according to an exemplary embodiment of the present invention, the operation sequence based comparison modeling module may perform an operation of converting the features related to the operation sequence among the selected main features into N-gram, an operation of generating an action vector through feature hashing for the features related to the operation sequence converted into the N-gram, and an operation of comparing the generated action vectors with action vectors related to the operation sequence of the normal files and action vectors related to the operation sequence of the malicious files in unit of block and calculating the normal similarity rate and the malicious similarity rate.

In the apparatus for verifying a malicious code machine learning classification model according to an exemplary embodiment of the present invention, the function sequence based comparison modeling module may perform an operation of preprocessing the features related to the function sequence among the selected main features, an operation of converting the preprocessed features related to the function sequence into N-gram, and an operation of comparing the features related to the function sequence converted into the N-gram with the features related to the function sequence of the normal files converted into the N-gram and the features related to the function sequence of the malicious files, respectively to calculate the normal similarity rate and the malicious similarity rate.

The apparatus for verifying a malicious code machine learning classification model according to an exemplary embodiment of the present invention may further include, a machine learning model verification unit verifying the reliability of the machine learning modeling module by comparing a result of predicting whether the file is normal or malicious, which is predicted through the machine learning modeling module with a result of determining whether the file is normal or malicious, which is output from the multi-layer cyclic verification subsystem.

Another exemplary embodiment of the present invention provides a method for verifying a malicious code machine learning classification model, which includes: (a) performing feature extracting and processing functions in an input file; and (b) performing multi-layer verification in order to determine whether the file is normal or malicious based on the extracted and processed features.

In the method for verifying a malicious code machine learning classification model according to an exemplary embodiment of the present invention, step (a) may include (a-1) extracting features related to static analysis information which may be obtained without execution of the file and features related to dynamic analysis information which may be obtained through execution of the file, and (a-2) selecting and categorizing main features which may be used at the time of performing a malicious action among the extracted features related to the static analysis information and features related to the dynamic analysis information.

In the method for verifying a malicious code machine learning classification model according to an exemplary embodiment of the present invention, step (b) may include (b-1) comparing the selected main features with the main features of the normal files and the main features of the malicious files, respectively to calculate the normal similarity rate and the malicious similarity rate, (b-2) comparing the features related to the operation sequence among the selected main features with the features related to the operation sequence of the normal files and the features related to the operation sequence of the malicious files, respectively to calculate the normal similarity rate and the malicious similarity rate, (b-3) comparing the features related to the function sequence among the selected main features with the features related to the function sequence of the normal files and the features related to the function sequence of the malicious files, respectively to calculate the normal similarity rate and the malicious similarity rate, and (b-4) computing the final normal similarity rate and the final malicious similarity rate based on the normal similarity rates and the malicious similarity rates calculated in steps (b-1) to (b-3) and determining whether the malicious suspicious file is normal or malicious by comparing the final normal similarity rate and the final malicious similarity rate.

In the method for verifying a malicious code machine learning classification model according to an exemplary embodiment of the present invention, step (b-1) may include acquiring the number of categories whose contents match each other by comparing contents of the main features classified for each selected category with the contents of the main features of the normal files and the contents of the main features of the malicious files, respectively, generating feature vectors by setting the categories whose contents match each other to 1 and setting the categories whose contents do not match each other to 0 based on the comparison result, computing a similarity rate for each feature by comparing the features of the categories whose contents match each other with the main features of the normal files and the main features of the malicious files, respectively in unit of block based on the number of categories whose contents match each other, and calculating the normal similarity rate for the normal file and the malicious similarity rate for the malicious file based on the feature vectors and the similarity rate for each feature.

In the method for verifying a malicious code machine learning classification model according to an exemplary embodiment of the present invention, step (b-2) may include converting the features related to the operation sequence among the selected main features into N-gram, generating an action vector through feature hashing for the features related to the operation sequence converted into the N-gram, and comparing the generated action vectors with action vectors related to the operation sequence of the normal files and action vectors related to the operation sequence of the malicious files in unit of block and calculating the normal similarity rate and the malicious similarity rate.

In the method for verifying a malicious code machine learning classification model according to an exemplary embodiment of the present invention, step (b-3) may include preprocessing the features related to the function sequence among the selected main features, converting the preprocessed features related to the function sequence into N-gram, and comparing the features related to the function sequence converted into the N-gram with the features related to the function sequence of the normal files converted into the N-gram and the features related to the function sequence of the malicious files, respectively to calculate the normal similarity rate and the malicious similarity rate.

The method for verifying a malicious code machine learning classification model according to an exemplary embodiment of the present invention may further include, after step (b), verifying the reliability of the machine learning modeling module by comparing a result of predicting whether the file is normal or malicious, which is predicted through the machine learning modeling module with the result determined in step (b).

According to an exemplary embodiment of the present invention, an apparatus and a method for verifying a malicious code machine learning classification model can verify a machine learning model that classifies malicious codes, thereby ensuring reliability for a prediction result of the machine learning model.

### BRIEF DESCRIPTION OF THE DRAWINGS

FIG. 1 is a diagram illustrating an apparatus for verifying a malicious code machine learning classification model according to an exemplary embodiment of the present invention.

FIG. 2 is a detailed block diagram of a main feature processing subsystem and a multi-layer cyclic verification subsystem illustrated in FIG. 1.

FIG. 3 is a detailed block diagram of a feature extraction module illustrated in FIG. 2.

FIG. 4 is a detailed block diagram of a main feature processing module illustrated in FIG. 2.

FIG. 5 is a flowchart of an operation of a main feature relative comparison module illustrated in FIG. 2.

FIG. 6 is a diagram for describing an operation of calculating a normal similarity rate and a malicious similarity rate in the main feature relative comparison module illustrated in FIG. 2.

FIG. 7 is a flowchart of an operation of an operation sequence based comparison modeling module illustrated in FIG. 2.

FIG. 8 is a flowchart of an operation of a function sequence based comparison modeling module illustrated in FIG. 2.

FIG. 9 is a flowchart of a method for verifying a malicious code machine learning classification model according to an exemplary embodiment of the present invention.

### DETAILED DESCRIPTION

The objects, specific advantages, and new features of the present invention will be more clearly understood from the following detailed description and the exemplary embodiments taken in conjunction with the accompanying drawings.

Terms or words used in the present specification and claims should not be interpreted as being limited to typical or dictionary meanings, but should be interpreted as having meanings and concepts which comply with the technical spirit of the present disclosure, based on the principle that an inventor can appropriately define the concept of the term to describe his/her own invention in the best manner.

In the present specification, when reference numerals refer to components of each drawing, it is to be noted that although the same components are illustrated in different drawings, the same components are denoted by the same reference numerals as possible.

The terms “first”, “second”, “one surface”, “other surface”, etc. are used to distinguish one component from another component and the components are not limited by the terms.

Hereinafter, in describing the present invention, a detailed description of related known art which may make the gist of the present invention unnecessarily ambiguous will be omitted.

Hereinafter, an exemplary embodiment of the present invention will be described in detail with reference to the accompanying drawings.

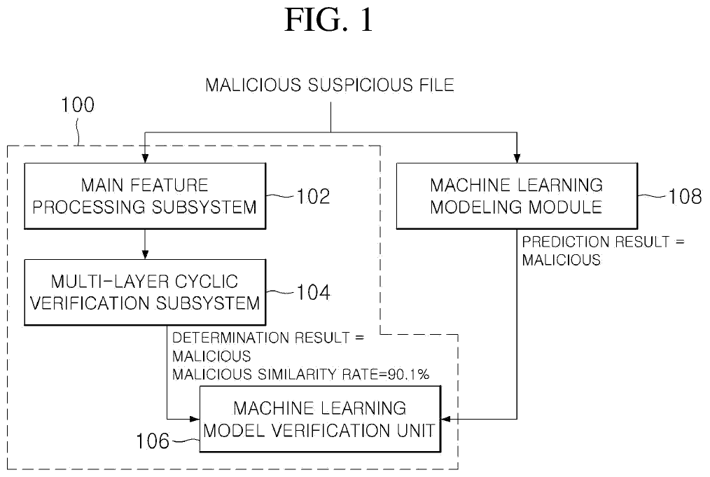

An apparatus 100 for verifying a malicious code machine learning classification model according to an exemplary embodiment of the present invention illustrated in FIG. 1 includes a main feature processing subsystem 102 for performing feature extraction and processing functions on files suspected of maliciousness, a multi-layer cyclic verification subsystem 104 for performing multi-layer verification to determine whether the file is normal or malicious based on the extracted and processed features, and a machine learning model verification unit 106 for verifying reliability of a machine learning modeling module 108 by comparing a result of classifying the file through the machine learning modeling module 108 with a result of determining whether the file is normal or malicious output from the multi-layer cyclic verification subsystem 104.

The machine learning modeling module 108 predicts predictive information for the file suspicious of maliciousness, that is, whether the file suspicious of maliciousness is a normal file or a malicious file based on various machine learning models including a Convolutional Neural Network (CNN), a Deep Neural Network (DNN), and the like.

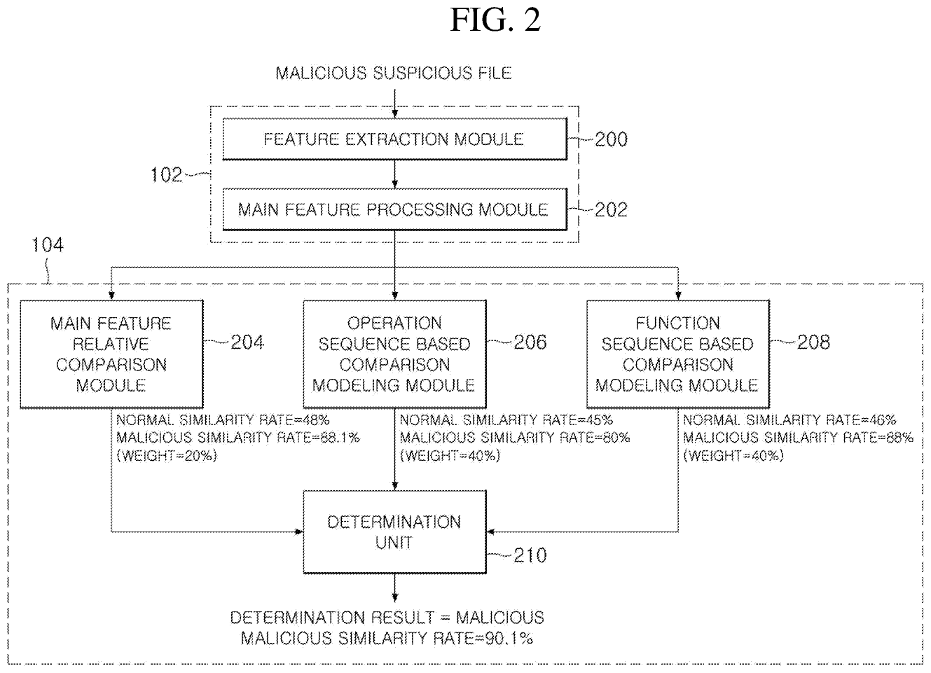

Referring to FIG. 2, the main feature processing subsystem 102 extracts and processes features from a malicious suspicious file and the multi-layer cyclic verification subsystem 104 performs multi-layer verification based on the extracted features.

Referring to FIG. 2, the main feature processing subsystem 102 includes a feature extraction module 200 extracting static analysis information and dynamic analysis information from the malicious suspicious file and a main feature processing module 202 selecting main features to be used for multi-layer cyclic verification among the extracted features.

The multi-layer cyclic verification subsystem 104 includes a main feature relative comparison module 204 performing multiple analysis using main meta information, an operation sequence based comparison modeling module 206 performing comparison based on features related to an operation sequence of files, a function sequence based comparison modeling module 208 performing comparison based on features related to a function sequence of the files, and a determination unit 210 determining whether the malicious suspicious file is normal or malicious by computing a final normal similarity rate and a final malicious similarity rate based on a normal similarity rate and a malicious similarity rate calculated by the main feature relative comparison module 204, the normal similarity rate and the malicious similarity rate calculated by the operation sequence based comparison modeling module 206, and the normal similarity rate and the malicious similarity rate calculated by the function sequence based comparison modeling module 208 and comparing the final normal similarity rate and the final malicious similarity rate.

Referring to FIG. 1, the operation sequence of the malicious code machine learning classification model verification apparatus according to an exemplary embodiment of the present invention is described below.

1) The machine learning modeling module 108 outputs the prediction result by predicting whether the malicious suspicious file is a normal file or a malicious file through various machine learning algorithms such as DNN/CNN.

2) The main feature processing subsystem 102 extracts static and dynamic features from the malicious suspicious file and selects main features among the extracted static and dynamic features in order to verify the prediction result of the machine learning modeling module 108.

3) The multi-layer cyclic verification subsystem 104 performs multi-layer cyclic verification using the selected main features. The multi-layer cyclic verification subsystem 104 outputs a determination result and a similarity rate indicating whether the malicious suspicious file is the normal file or the malicious file.

4) The machine learning model verification unit 106 verifies reliability for the prediction result of the machine learning modeling module 108 by checking a similarity between a value obtained through the multi-layer verification by the multi-layer cyclic verification subsystem 104 and the determination result output by the machine learning modeling module 108.

Referring to the accompanying drawings, the operation of the malicious code machine learning classification model verification apparatus 100 according to an exemplary embodiment of the present invention will be described below in detail.

First, the machine learning modeling module 108 performs modeling through algorithms such as CNN and DNN and predicts and outputs normal or abnormal (malicious) results to malicious suspicious files requested for analysis.

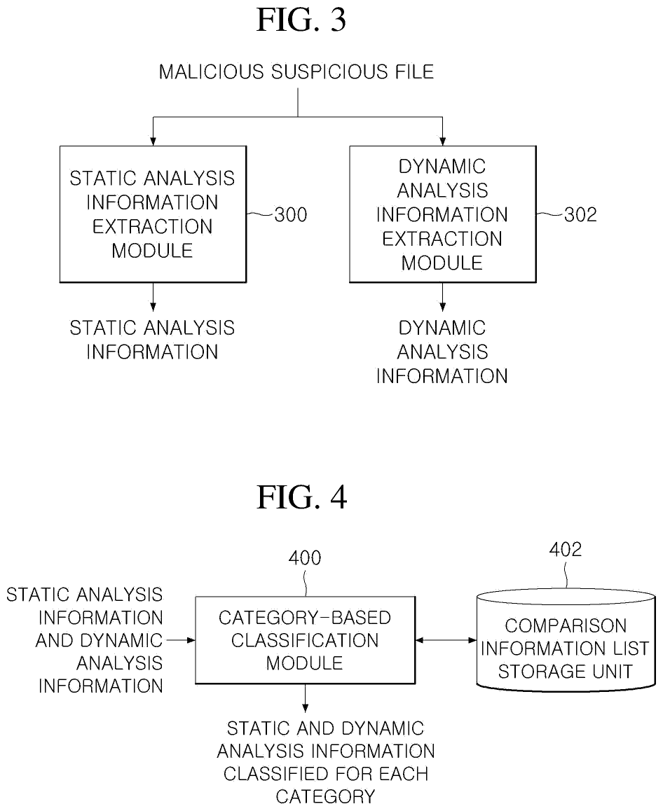

As illustrated in FIG. 3, the feature extraction module 200 includes a static analysis information extraction module 300 and a dynamic analysis information extraction module 302, and the static analysis information extraction module 300 extracts features related to the static analysis information which may be obtained without executing a file suspicious of maliciousness from the malicious suspicious file and the dynamic analysis information extraction module 302 extracts features related to the dynamic analysis information which may be obtained by executing the file from the malicious suspicious file. The features related to the static analysis information include PE info, fuzzy hash, and development environment information and the features related to the dynamic analysis information include an operation sequence, a function sequence, a registry, a network communication information, and the like.

As illustrated in FIG. 4, the main feature processing module 202 includes a category-based classification module 400 and a comparison information list storage unit 402 and the category-based classification module 400 selects and categorizes a total of 15 main features among features which may be used at the time of performing a malicious action among the extracted features related to the static analysis information and features related to the dynamic analysis information and uses 15 categorized main features as comparison information. Further, the corresponding data are processed so as to be used by the multi-layer cyclic verification subsystem 104.

Detailed items of the main features are shown in Table 1.

TABLE 1

| No. | Main features | Description |
|---|---|---|
| 1 | MD5, SHA-1, Authentihash | Compare Hash values before comparing similar |
| | | files to compare whether files are the same. |
| 2 | Imphash | Enabled to be generated in a PE file and generate a |
| | | hash value based on names of libraries and |
| | | functions having a specific sequence. This is an |
| | | item which may match even in case of a similar file. |
| 3 | File Metadata | Variant malicious files may be similar in name, |
| | | type, size, etc., compared to the original file, and |
| | | this is the widest range of comparison. |
| 4 | Fuzzy hash | If a part of the document is modified by a block- |
| | | level comparison with the size specified by the user, |
| | | it is confirmed that the part of the document is |
| | | similar. |
| 5 | Development environment | As a tool for determining which file type a binary |
| | and language | based on a file binary, used together with File type. |
| 6 | File version information | The file version information includes values |
| | | including Copyright, Product, etc., and it is checked |
| | | whether an attack group is the same through the |
| | | values. |
| 7 | PE information | PE section information and a compile time are |
| | | utilized and used as information for confirming the |
| | | similar file. |
| 8 | Contained Resource By | It is checked which language development is made |
| | Type | by on a code through information including a |
| | | resource. |
| 9 | Operation Sequence | Used for a deep-learning model by extracting inter- |
| | | file operation sequence information. |
| 10 | Strings | Contents in a binary file are extracted to check |
| | | whether there are similar contents. |
| 11 | Function Sequence Statistics | It is checked which function is high in frequency |
| | Comparison | and similarity is compared. |
| 12 | Function Sequence analysis | The function sequence is extracted and used as a |
| | | factor of a similarity comparison algorithm through |
| | | cosine similarity. |
| 13 | Registry comparison | A changed registry value is compared to check |
| | | whether a corresponding file is a file performing a |
| | | similar function. |
| 14 | File access comparison | Read/written/changed route and contents of the file |
| | | are checked to confirm the similarity. |
| 15 | Communication information | The similarity is confirmed by checking a |
| | (network) | communication band, etc., at the time of executing |
| | | the file. |

Referring to FIGS. 1 and 2, in an exemplary embodiment of the present invention, the multi-layer cyclic verification subsystem 104 performs multi-verification using 15 main features and compares the similarity between the normal file and the malicious file for the malicious suspicious file.

In detail, the multi-layer cyclic verification subsystem 104 performs a total of three similarity comparison operations of main feature relative comparison by the main feature relative comparison module 204, operation sequence based comparison by the operation sequence based comparison modeling module 206, and function sequence based comparison by the function sequence based comparison modeling module 208 and the determination unit 210 computes the final normal similarity rate and the final malicious similarity rate by applying specific weights to performed results, respectively. For example, the determination unit 210 acquires the final normal similarity rate and the final malicious similarity rate by applying a weight 20% to the result of the main feature relative comparison, a weight of 40% to the result of the operation sequence based comparison, and a weight of 40% to the result of the function sequence based comparison.

According to the present invention, since it is determined whether the corresponding file is normal or malicious by assigning a higher weight to action based comparison such as the operation sequence and the function sequence than relative comparison of the features, a reliable result may be derived. In addition, the determination unit 210 compares the final normal similarity rate with the final malicious similarity rate and determines the malicious suspicious file as the normal file or the malicious file based on the large similarity rate.

The operation of the multi-layer cyclic verification subsystem 104 will be described below in detail.

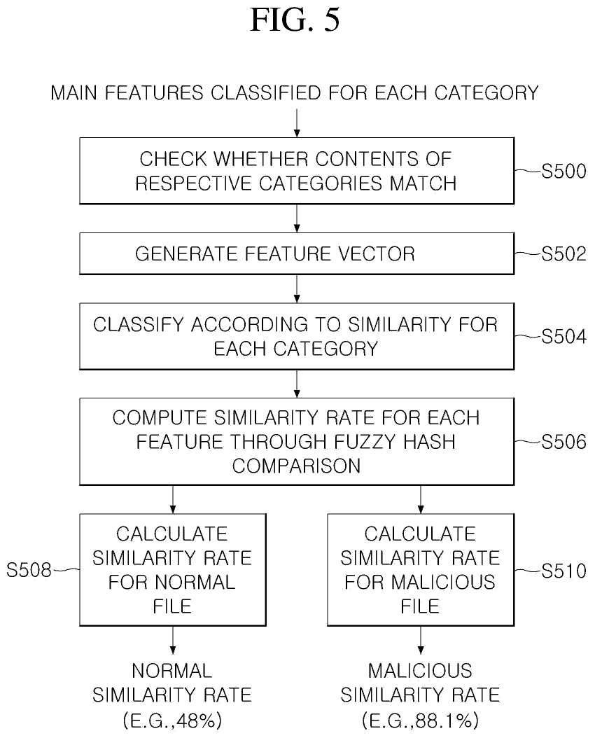

Referring to FIGS. 2 and 5, the main feature relative comparison module 204 compares contents of the main features classified for each selected category with the contents of the main features of the normal file and the contents of the main features of the malicious files and acquires the number of categories whose contents match (operation S500).

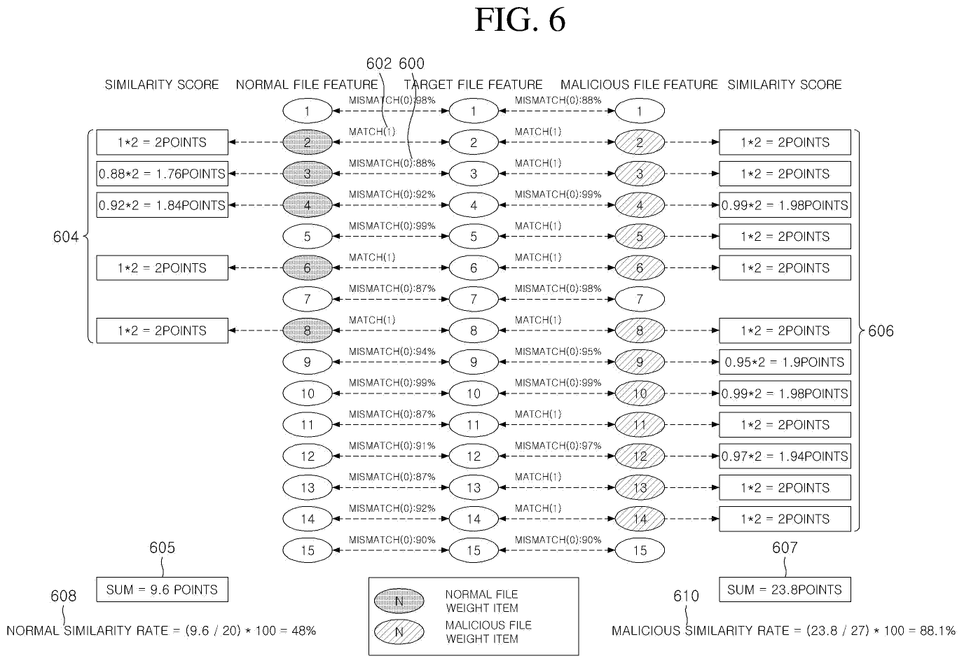

Next, the main feature relative comparison module 204 sets the category whose contents exactly match to 1 based on the comparison result in operation S500 and sets the category whose contents do not exactly match to 0 to generate a feature vector according to the category (operation S502). For example, if feature 2, feature 6, and feature 8 exactly match as the result of comparing the selected main features (target file features in FIG. 6) with the normal file feature as illustrated in FIG. 6, [0,1,0,0,0,1,0,1,0,0,0,0,0,0,0] is generated as the feature vector. In addition, if features 2, 3, 5, 6, 8, 11, 13, and 14 exactly match as the result of comparing the selected main features (target file features in FIG. 6) with the malicious file feature, [0,1,1,0,1,1,0,1,0,0,1,0,1,1,0] is generated as the feature vector.

Next, the main feature relative comparison module 204 performs classification according to the similarity for each category (operation S504), and compares features of categories whose contents match with the main features of the normal files and the main features of the malicious files, respectively in units of block through Fuzzy hash comparison according to the number of categories whose contents match to compute the similarity rate for each feature (operation S506). For example, when the number of categories whose contents match is 6, in order to enhance accuracy, the features of the categories whose contents match are compared with the main features of the normal file and the malicious files in which the number of categories whose contents match is 6, respectively in unit of block to compute the similarity rate for each feature.

Next, the main feature relative comparison module 204 calculates the similarity rate for the normal file based on the feature vectors and the similarity rate for each feature (operation S508) and calculates the similarity rate for the malicious file (operation S510).

FIG. 6 illustrates an operation (operation S508) of calculating the similarity rate for the normal file and an operation (operation S510) of calculating the similarity rate for the malicious file in detail.

In FIG. 6, reference numeral 600 represents a similarity rate computed for feature 1 as one of similarity rates for each feature computed in operation S506. Numbers written in % next to match (1) and mismatch (0) indicate the similarity rate for each feature.

In order to calculate the normal similarity rate and the malicious similarity rate as illustrated in FIG. 6, first, based on information 602 indicating whether the features of the feature vectors match and feature based similarity rate 600, each feature based similarity score 604 is computed. The information 602indicating whether features match in the feature vector is “1” when the features match each other and “0” when the features do not match each other. In FIG. 6, match (1) and mismatch (0) indicate “1” and “0”, respectively.

Meanwhile, the feature based similarity score 604 is computed as follows.

When the features exactly match each other, one point is assigned and when the features do not exactly match each other, the score is not assigned. Further, when the features that are mainly regarded in normality or maliciousness match each other at the time of computing the score, additional addition of (×2) is assigned.

Even though the features do not exactly match each other, the additional addition is assigned to the important feature in discriminating whether the file is normal or malicious. Accordingly, for important features in discriminating whether the file is normal or malicious even when the features do not match each other, a similarity rate of fuzzy hash, i.e., the feature based similarity rate (e.g., reference numeral 600) is reflected in the addition.

As illustrated in FIG. 6, the main features regarded when being compared with the normal file feature are features 2, 3, 4, 6, and 8, and the main features regarded when being compared with the malicious file feature are features 2 to 6 and features 8 to 14.

A normal similarity rate 608 is computed by (the sum 605 of the feature based similarity score 604/a maximum score value which may be obtained from the normal file)×100.

A malicious similarity rate 610 is computed by (the sum 607 of the feature based similarity score 606/a maximum score value which may be obtained from the malicious file)×100.

The maximum score value which may be obtained from the normal file is (10 (the number of features other than the main feature among the normal file features)×1)+(5(the number of main features among the normal file features)×2)=20.

The maximum score value which may be obtained from the malicious file is (3 (the number of features other than the main feature among the malicious file features)×1)+(12(the number of main features among the malicious file features)×2)=27.

Accordingly, in the case of FIG. 6, the normal similarity rate 608 is (9.6/20)×100=48% and the malicious similarity rate 610 is (23.8/27)×100=88.1%.

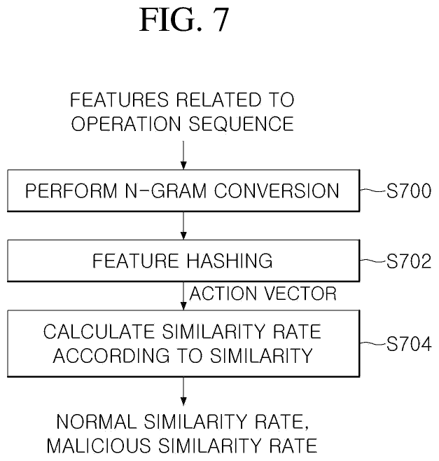

Referring to FIGS. 2 and 7, the operation sequence based comparison modeling module 206 converts features related to the operation sequence among the main features selected by the main feature processing module 202 into N-gram in order to easily determine the sequence (operation S700).

Next, the operation sequence based comparison modeling module 206 generates a hash table having a size of 4096 bytes through feature hashing for the features related to the operation sequence converted into the N-gram and since a value may be excessively large or small by an operation frequently called at the time of generating the hash table, the operation sequence based comparison modeling module 206 generates an action vector by changing the value to −1, 0, and 1 through normalization (operation S702).

Next, the operation sequence based comparison modeling module 206 compares the generated action vectors with action vectors related to the operation sequence of the normal files and action vectors related to the operation sequence of the malicious files in unit of block and calculates the normal similarity rate and the malicious similarity rate (operation S704).

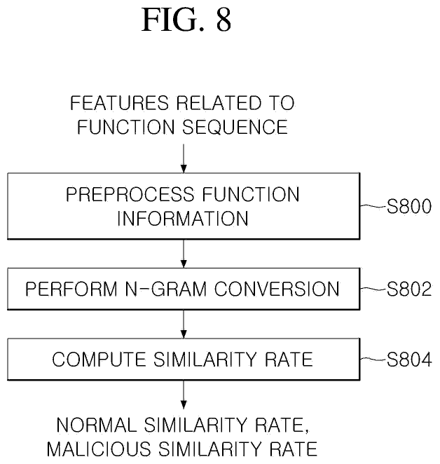

Referring to FIGS. 2 and 8, the function sequence based comparison modeling module 208 performs preprocessing such as indexing for the features related to the function sequence among the main features selected by the main feature processing module 202 (operation S800).

Next, the function sequence based comparison modeling module 209 converts the features related to the pre-processed function sequence into N-grams in order to easily determine the sequence (operation S802) and compares the features related to the function sequence converted into the N-gram with the features related to the function sequence of the normal files converted into the N-gram and the features related to the function sequence of the malicious files, respectively by using a Cosine similarity technique to calculate the normal similarity rate and the malicious similarity rate (operation S804).

Referring to FIG. 2, the determination unit 210 determines whether the malicious suspicious file is normal or malicious by computing the final normal similarity rate and the final malicious similarity rate based on the normal similarity rate and the malicious similarity rate calculated by the main feature relative comparison module 204, the normal similarity rate and the malicious similarity rate calculated by the operation sequence based comparison modeling module 206, and the normal similarity rate and the malicious similarity rate calculated by the function sequence based comparison modeling module 208 and comparing a final normal similarity rate and a final malicious similarity rate.

In an exemplary embodiment of the present invention, assuming that the similarity rate is calculated as illustrated in FIG. 2, the determination unit 210 determines that the malicious suspicious file is malicious and outputs 90.1% as the malicious similarity rate because the final malicious similarity rate is larger than the final normal similarity rate.

Referring back to FIG. 1, the machine learning model verification unit 106 verifies the reliability of the machine learning modeling module 108 by comparing the result of predicting whether the malicious suspicious file is normal or malicious through the machine learning modeling module 108 with a result of determining whether the malicious suspicious file output by the multi-layer cyclic verification subsystem 104 is normal or malicious.

For example, the machine learning modeling module 108 predicts that the malicious suspicious file is malicious and when predicted model determination accuracy is 94%, a probability that identification will be unsuccessful is 6% and the malicious code machine learning classification model verification apparatus 100 according an exemplary embodiment of the present invention performs verification therefor.

In an exemplary embodiment of the present invention, the multi-layer cyclic verification subsystem 104 determines that the malicious suspicious file is malicious and computes the malicious similarity rate as 90.1% and the machine learning modeling module 108 predicts that the malicious suspicious file is malicious and since both result values are malicious, and as a result, the malicious suspicious file is finally determined to be malicious.

The machine learning model verification unit 106 outputs a verification result that the prediction result of the machine learning modeling module 108 is reliable when the prediction result of the machine learning modeling module 108 is the same as the result determined by the multi-layer cyclic verification subsystem 104 and outputs a verification result that the prediction result of the machine learning modeling module 108 is not reliable when the prediction result of the machine learning modeling module 108 is not the same as the result determined by the multi-layer cyclic verification subsystem 104.

In an exemplary embodiment of the present invention, since the prediction result of the machine learning modeling module 108 and the result determined in the multi-layer cyclic verification subsystem 104 are the same as each other as being malicious, the machine learning model verification unit 106 outputs the verification result that the prediction result of the machine learning modeling module 108 is reliable.

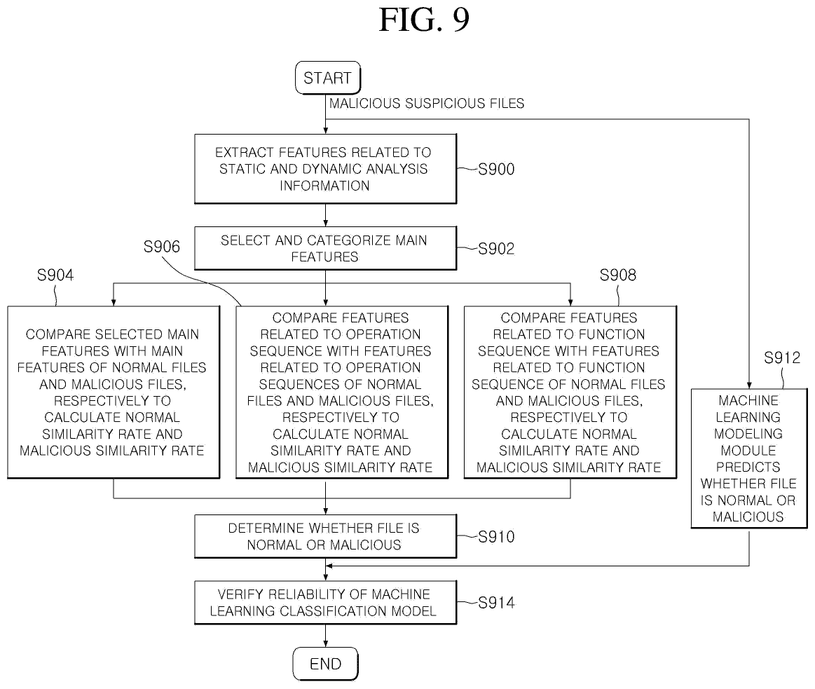

Meanwhile, FIG. 9 is a flowchart of a method for verifying a malicious code machine learning classification model according to an exemplary embodiment of the present invention.

Referring to FIG. 9, the method for verifying a malicious code machine learning classification module according to an exemplary embodiment of the present invention includes performing feature extraction and processing functions on malicious suspicious files (steps S900 and S902), performing multi-layer verification to determine whether the malicious suspicious file is normal or malicious based on the extracted and processed features (steps S904, S906, S908, and S910), and verifying the reliability of the machine learning modeling module 108 by comparing a result of classifying the malicious suspicious files through a machine learning modeling module 108 with results determined in performing the multi-layer verification (steps S904, S906, S908, and S910) (step S914).

The method for verifying a malicious code machine learning classification model according to an exemplary embodiment of the present invention will be described in detail with reference to FIG. 9.

In step S900, the feature extraction module 200 extracts features related to the static analysis information that may be obtained without execution of the malicious suspicious file and features related to the dynamic analysis information that may be obtained through execution of the malicious suspicious file.

In step S902, the main feature processing module 202 selects and categorizes main features which may be used at the time of performing the malicious action among the extracted features related to the static analysis information and features related to the dynamic analysis information.

In step S904, the main feature relative comparison module 204 compares the selected main features with the main features of the normal files and the main features of the malicious files, respectively to calculate the normal similarity rate and the malicious similarity rate.

In step S906, the operation sequence based comparison modeling module 206 compares the features related to the operation sequence among the selected main features with the features related to the operation sequence of the normal files and the features related to the operation sequence of the malicious files, respectively to calculate the normal similarity rate and the malicious similarity rate.

In step S908, the function sequence based comparison modeling module 208 compares the features related to the function sequence among the selected main features with the features related to the function sequence of the normal files and the features related to the function sequence of the malicious files, respectively to calculate the normal similarity rate and the malicious similarity rate.

In step S910, the determination unit 210 computes the final normal similarity rate and the final malicious similarity rate based on the normal similarity rates and the malicious similarities calculated in steps S904, S906, and S908 and determines whether the malicious suspicious file is normal or malicious by comparing the final normal similarity rate and the final malicious similarity rate.

In step S912, the machine learning modeling module 108 predicts whether the malicious suspicious file is normal or malicious based on the machine learning model.

In step S914, the machine learning model verification unit 106 compares the result predicted by the machine learning modeling module 108 in step S912 with the result determined in step S910 to verify the reliability of the machine learning modeling module 108.

Meanwhile, step S904 includes comparing the contents of the main features classified for each selected category with the contents of the main features of the normal file and the contents of the main features of the malicious files, respectively to obtain the number of categories whose contents match each other (S500 in FIG. 5), generating the feature vectors by setting the categories whose contents match each other to 1 and setting the categories whose contents do not match each other to 0 based on the comparison result (S502 in FIG. 5), comparing the features of the categories whose contents match each other with the main features of the normal files and the main features of the malicious files, respectively in units of block based on the number of categories whose contents match each other to compute the similarity rate for each feature (S504 and S506 of FIG. 5), and calculating the normal similarity rate for the normal file and the malicious similarity rate for the malicious file based on the feature vectors and the similarity rate for each feature (S508 and S510 of FIG. 5).

Step S906 includes converting the features related to the operation sequence among the selected main features into N-gram (S700 of FIG. 7), generating an action vector through feature hashing of the features related to the operation sequence converted into the N-gram (S702 of FIG. 7), and comparing the generated action vector with the action vector related to the operation sequence of the normal files and the action vector related to the operation sequence of the malicious files in units of block to calculate the normal similarity rate and the malicious similarity rate (S704 of FIG. 7).

Step S908 includes preprocessing the features related to the function sequence among the selected main features (S800 of FIG. 8), converting the preprocessed features related to the function sequence into N-gram (S802 of FIG. 8), and comparing the features related to the function sequence converted into the N-gram with the features related to the function sequence of the normal files and the features related to the function sequence of the malicious files converted into the N-gram, respectively to calculate the normal similarity rate and the malicious similarity rate (S804 of FIG. 8).

While the present invention has been particularly described with reference to detailed exemplary embodiments thereof, it is to specifically describe the present invention and the present invention is not limited thereto and it will be apparent that modification and improvement of the present invention can be made by those skilled in the art within the technical spirit of the present invention.

Simple modification and change of the present invention all belong to the scope of the present invention and a detailed protection scope of the present invention will be clear by the appended claims.

What is claimed is:

1. An apparatus for verifying a malicious code machine learning classification model, the apparatus comprising:
a main feature processing subsystem performing feature extracting and processing functions in an input file; and
a multi-layer cyclic verification subsystem performing multi-layer verification in order to determine whether the file is normal or malicious based on the extracted and processed features.

2. The apparatus of claim 1, wherein the main feature processing subsystem includes:
a feature extraction module extracting features related to static analysis information which may be obtained without execution of the file and features related to dynamic analysis information which may be obtained through execution of the file, and
a main feature processing module selecting and categorizing main features which may be used at the time of performing a malicious action among the extracted features related to the static analysis information and features related to the dynamic analysis information.

3. The apparatus of claim 2, wherein the multi-layer cyclic verification subsystem includes:
a main feature relative comparison module comparing the selected main features with the main features of the normal files and the main features of the malicious files, respectively to calculate the normal similarity rate and the malicious similarity rate,
an operation sequence based comparison modeling module comparing the features related to the operation sequence among the selected main features with the features related to the operation sequence of the normal files and the features related to the operation sequence of the malicious files, respectively to calculate the normal similarity rate and the malicious similarity rate,
a function sequence based comparison modeling module comparing the features related to the function sequence among the selected main features with the features related to the function sequence of the normal files and the features related to the function sequence of the malicious files, respectively to calculate the normal similarity rate and the malicious similarity rate, and
a determination unit determining whether the malicious suspicious file is normal or malicious by computing the final normal similarity rate and the final malicious similarity rate based on the normal similarity rate and the malicious similarity rate calculated by the main feature relative comparison module, the normal similarity rate and the malicious similarity rate calculated by the operation sequence based comparison modeling module, and the normal similarity rate and the malicious similarity rate calculated by the function sequence based comparison modeling module and comparing the final normal similarity rate and the final malicious similarity rate.

4. The apparatus of claim 3, wherein the main feature relative comparison module performs:
an operation of acquiring the number of categories whose contents match each other by comparing contents of the main features classified for each selected category with the contents of the main features of the normal files and the contents of the main features of the malicious files, respectively,
an operation of generating feature vectors by setting the categories whose contents match each other to 1 and setting the categories whose contents do not match each other to 0 based on the comparison result,
an operation of computing a similarity rate for each feature by comparing the features of the categories whose contents match each other with the main features of the normal files and the main features of the malicious files, respectively in unit of block based on the number of categories whose contents match each other, and
an operation of calculating the normal similarity rate for the normal file and the malicious similarity rate for the malicious file based on the feature vectors and the similarity rate for each feature.

5. The apparatus of claim 3, wherein the operation sequence based comparison modeling module performs:
an operation of converting the features related to the operation sequence among the selected main features into N-gram,
an operation of generating an action vector through feature hashing for the features related to the operation sequence converted into the N-gram, and
an operation of comparing the generated action vectors with action vectors related to the operation sequence of the normal files and action vectors related to the operation sequence of the malicious files in unit of block and calculating the normal similarity rate and the malicious similarity rate.

6. The apparatus of claim 3, wherein the function sequence based comparison modeling module performs:
an operation of preprocessing the features related to the function among the selected main features,
an operation of converting the preprocessed features related to the function sequence into N-gram, and
an operation of comparing the features related to the function sequence converted into the N-gram with the features related to the function sequence of the normal files converted into the N-gram and the features related to the function sequence of the malicious files, respectively to calculate the normal similarity rate and the malicious similarity rate.

7. The apparatus of claim 1, further comprising:
a machine learning model verification unit verifying the reliability of the machine learning modeling module by comparing a result of predicting whether the file is normal or malicious, which is predicted through the machine learning modeling module with a result of determining whether the file is normal or malicious, which is output from the multi-layer cyclic verification subsystem.

8. A method for verifying a malicious code machine learning classification model, the method comprising:
(a) performing feature extracting and processing functions in an input file; and
(b) performing multi-layer verification in order to determine whether the file is normal or malicious based on the extracted and processed features.

9. The method of claim 8, wherein step (a) includes:
(a-1) extracting features related to static analysis information which may be obtained without execution of the file and features related to dynamic analysis information which may be obtained through execution of the file, and
(a-2) selecting and categorizing main features which may be used at the time of performing a malicious action among the extracted features related to the static analysis information and features related to the dynamic analysis information.

10. The method of claim 9, wherein step (b) includes:
(b-1) comparing the selected main features with the main features of the normal files and the main features of the malicious files, respectively to calculate the normal similarity rate and the malicious similarity rate,
(b-2) comparing the features related to the operation sequence among the selected main features with the features related to the operation sequence of the normal files and the features related to the operation sequence of the malicious files, respectively to calculate the normal similarity rate and the malicious similarity rate,
(b-3) comparing the features related to the function sequence among the selected main features with the features related to the function sequence of the normal files and the features related to the function sequence of the malicious files, respectively to calculate the normal similarity rate and the malicious similarity rate, and
(b-4) computing the final normal similarity rate and the final malicious similarity rate based on the normal similarity rates and the malicious similarities calculated in steps (b-1) to (b-3) and determines whether the malicious suspicious file is normal or malicious by comparing the final normal similarity rate and the final malicious similarity rate.

11. The method of claim 10, wherein step (b-1) includes:
acquiring the number of categories whose contents match each other by comparing contents of the main features classified for each selected category with the contents of the main features of the normal files and the contents of the main features of the malicious files, respectively,
generating feature vectors by setting the categories whose contents match each other to 1 and setting the categories whose contents do not match each other to 0 based on the comparison result,
computing a similarity rate for each feature by comparing the features of the categories whose contents match each other with the main features of the normal files and the main features of the malicious files, respectively in unit of block based on the number of categories whose contents match each other, and
calculating the normal similarity rate for the normal file and the malicious similarity rate for the malicious file based on the feature vectors and the similarity rate for each feature.

12. The method of claim 10, wherein step (b-2) includes:
converting the features related to the operation sequence among the selected main features into N-gram,
generating an action vector through feature hashing for the features related to the operation sequence converted into the N-gram, and
comparing the generated action vectors with action vectors related to the operation sequence of the normal files and action vectors related to the operation sequence of the malicious files in unit of block and calculating the normal similarity rate and the malicious similarity rate.

13. The method of claim 10, wherein step (b-3) includes:
preprocessing the features related to the function sequence among the selected main features,
converting the preprocessed features related to the function sequence into N-gram, and
comparing the features related to the function sequence converted into the N-gram with the features related to the function sequence of the normal files converted into the N-gram and the features related to the function sequence of the malicious files, respectively to calculate the normal similarity rate and the malicious similarity rate.

14. The method of claim 8, further comprising:
after step (b),
verifying the reliability of the machine learning modeling module by comparing a result of predicting whether the file is normal or malicious, which is predicted through the machine learning modeling module with the result determined in step (b).
